(19) United States
(12) Patent Application Publication
(10) Pub. No.: US 2015/0020605 A1
(43) Pub. Date: Jan. 22, 2015

(54) SYSTEM FOR LOCATING ELECTRIC CABLES

(71) Applicant: Caterpillar Inc., Peoria, IL (US)

(72) Inventors: Michael D. Braunstein, Washington, IL (US); Eric A. Reiners, Washington, IL (US)

(73) Assignee: Caterpillar Inc., Peoria, IL (US)

(21) Appl. No.: 14/510,147

(22) Filed: Oct. 9, 2014

(51) Int. Cl. G01L 1/24

(52) U.S. Cl. CPC G01L 1/242
USPC 73/800

(57) ABSTRACT

A system for locating a cable tethered from a mobile machine along a worksite is disclosed. The cable transmits electric power to the mobile machine from a power source. A fiber optic cable is disposed between the power source and the mobile machine along with the cable to detect a position of the electric cable along the worksite. The system includes a shape sensing device to communicate with the fiber optic cable and generate a position data set. A positioning device determines a position of one of the mobile machine and the power source. A controller communicates with the shape sensing device and the positioning device and determines an avoidance region based on the position data set and the position of one of the mobile machine and the power source. The avoidance region corresponds to a region for avoidance by equipment or personnel.

### TECHNICAL FIELD

The present disclosure relates to a system for locating an electric cable, and more particularly to a system for locating an electric cable associated with a machine in a worksite.

### BACKGROUND

Machines such as excavators, mining shovels, loaders, drills and the like may be used for mining or other earth moving operations, and in some cases may be either electrically or hydraulically powered by a remotely located power source, such as a generator or pump. For example, mining shovels which are employed to dig and load material may be connected to a remote power source such as an electrical generator via electric cables that are tethered to a rear portion of the mining shovels. Similarly, hydraulic conduits may be connected between a remotely connected pump to a machine. The electric cables or conduits may be running on the ground of the worksite during operation of the machine and may run off a spool that allows the operating cable length to change as needed as the machine moves from one work location to another. For example, as an electric shovel moves between work locations, and swings between a work surface and the off-highway truck to load the earthen material, the position of the electric cable providing power to the machine changes. Similarly, as an electric drill moves from drilling position to drilling position to execute a desired drilling or blast pattern, the position of a tethered electric cable or conduits will change. As expected, the position of an electric cable or conduit in these operations may be difficult to track, which can be problematic for other machines operating on the site.

Off-highway trucks and other machines typically found on a work or minesite, such as dozers, motor graders, and service vehicles, may need to navigate in the vicinity of the remotely powered machine. For example, haul trucks may move to and from the shovel location to transport the earthen material from the worksite. An operator of the off-highway truck may have to avoid contact with the electric cables so as to prevent damage to both the electric cables and the truck. However, mobility and navigation around the electric cables may be difficult because the operator may be unable to see the ground, and thus locate the electric cables, near the truck. Environmental and site conditions may also impede an operator's ability to locate the cable.

Locating such cables can prove even more problematic when employing autonomous or semi-autonomous machines and systems on a worksite. An autonomous machine may include an on-board controller that controls machine propulsion and steering to guide the machine between one or more points on the worksite during operation. An autonomous machine may employ one or more maps with the location of pre-identified obstacles that are to be avoided, or may include on-board devices such as radar, LIDAR, cameras, and the like for object detection and avoidance, however, such systems may have difficulty with detecting the position of cables.

U.S. Pat. No. 7,793,442 discloses an avoidance system for a mobile earthmoving machine. The avoidance system includes a sensor system to periodically detect a position of a cable tethered from the machine within a worksite and generate a position data set in response to the position of the cable. A controller is associated with the sensor system and determines a cable avoidance region based on the position data set.

### SUMMARY OF THE DISCLOSURE

In the following description, the invention is described in the context of electric cables tethered to an electrically powered machine. However, one of skill in the art should appreciate that the invention may equally apply to fluid conduits connected to a tethered machine. In one aspect of the present disclosure, a system for locating an electric cable tethered from a mobile machine along a worksite at or above a surface of the worksite is provided. The electric cable is configured to transmit electric power to the mobile machine from a remotely located power source. The system includes a fiber optic cable associated with at least a portion of the electric cable. The fiber optic cable is disposed between the power source and the mobile machine along at least a portion of the electric cable. The fiber optic cable includes at least one core and a plurality of strain sensors distributed along a length of the at least one core. The system further includes a shape sensing device disposed in communication with the fiber optic cable. The shape sensing device is configured to receive signals from the plurality of strain sensors. The shape sensing device is further configured to generate a position data set indicative of a shape of the fiber optic cable. The system further includes a positioning device configured to determine a position of at least one of the mobile machine and the power source. The system also includes a controller disposed in communication with the shape sensing device and the positioning device. The controller is configured to determine a position of the electric cable along the worksite at or above a surface of the worksite based on the position data set and the position of at least one of the mobile machine and the power source. The controller is further configured to determine an avoidance region based on the position of the electric cable. The avoidance region is a region for avoidance by equipment or personnel.

Other features and aspects of this disclosure will be apparent from the following description and the accompanying drawings.

### BRIEF DESCRIPTION OF THE DRAWINGS

FIG. 1 is a schematic plan view of a worksite including a system for locating an electric cable associated with a mobile machine in the worksite, according to an embodiment of the present disclosure;

FIG. 2 is a sectional perspective view of a fiber optic cable associated with the electric cable, according to an embodiment of the present disclosure; and

FIG. 3 is a block diagram illustrating the system for locating the electric cable associated with the mobile machine, according to an embodiment of the present disclosure.

### DETAILED DESCRIPTION

Wherever possible, the same reference numbers will be used throughout the drawings to refer to the same or the like parts.

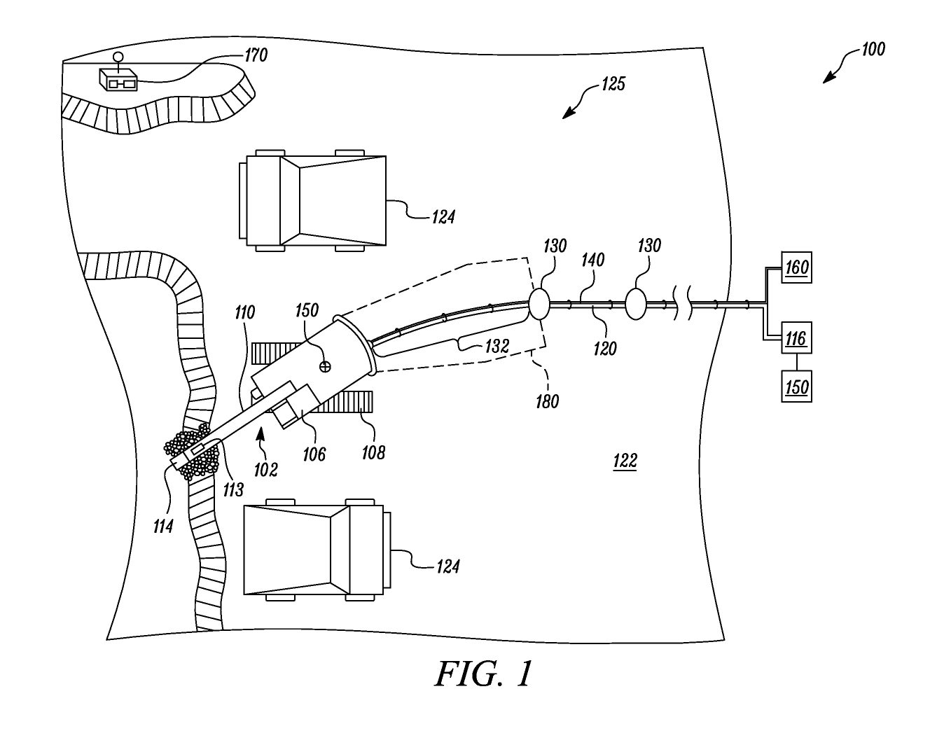

FIG. 1 shows a schematic top view of a worksite 100. A mobile machine 102 is shown to be operating at the worksite 100. The mobile machine 102 may be, for example, an excavator, a mining shovel, a drilling machine or the like. The mobile machine 102 may be self-propelled and may include a body 106 rotatable relative to an undercarriage (not shown). The undercarriage of the mobile machine 102 may be supported on ground engaging members 108. The ground engaging members 108 may be wheels or tracks. The mobile machine 102 may further include a boom 110 operatively coupled to the body 106 of the mobile machine 102. A stick 113 may be operatively coupled to a free end of the boom 110. Further, an implement 114 may be operatively coupled to the stick 113. The implement 114 may be configured to perform various earth moving operations. The implement 114 may be a power shovel, a bucket or the like known in the art. The mobile machine 102 may further include one or more electric motors (not shown) configured to provide propulsion to the mobile machine 102, and actuate the boom 110 and the implement 114. An electric cable 120 may be connected to the mobile machine 102. The electric cables 120 may be configured to transmit electric power to the electric motors from a power source 116. The electric cable 120 may include one or more electrically conductive members, such as wires, encased within an outer casing. The power source 116 may be located remotely with respect to the worksite 100.

The mobile machine 102 may be configured to travel along the worksite 100, such as an open-pit mine The body 106 may rotate to various angles in order to facilitate the implement 114 to excavate and load material from various locations of the worksite 100 along the path of rotation. Further, the implement 114 may be configured to unload material into one or more mobile equipment 124. The mobile equipment 124 may be, for example, an off-highway truck for transporting material from the worksite 100. The mobile equipment 124 may be autonomously controlled or manually controlled by an operator.

A system 125 may be provided to locate the electric cable 120, according to an embodiment of the present disclosure. The system 125 may include one or more cable guides 130 configured to guide the electric cable 120 above a surface 122 of the worksite 100. Each of the cable guides 130 may include an elongate body (not shown) disposed vertically on the surface 122 of the worksite 100. The elongate body may be configured to stabilize the corresponding cable guide 130 against tension and movement of the electric cable 120. Each of the cable guide 130 may further include a guiding member (not shown) disposed at a top end of the elongated body. The guiding member may be configured to direct the electric cable 120 in response to movement by the mobile machine 102. The guiding member may be a pulley, a rotatable spool, a roller bearing, or the like. Thus, the elongated body and the guiding member may elevate the electric cable 120 to a height above the surface 122 of the worksite 100 to allow the mobile equipment 124 to travel between adjacent cable guides 130 and underneath the electric cable 120. A portion 132 of the electric cable 120 between the mobile machine 102 and an adjacent cable guide 130 may be draped along the surface 122 of the worksite 100. Further, the portion 132 of the electric cable 120 may be provided with slack to allow free movement of the electric cable 120 in accordance with a movement of the mobile machine 102.

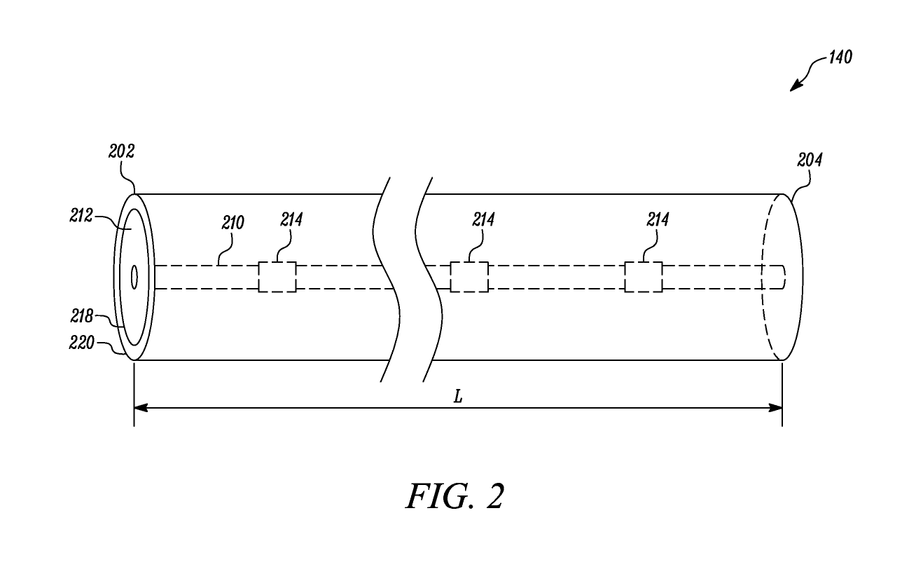

The system 125 may further include a fiber optic cable 140. The fiber optic cable 140 may extend between the mobile machine 102 and the power source 116 and connected to the electric cable 120 along a length thereof. Specifically, the fiber optic cable 140 may include a first end (shown in FIG. 2) adjacent to the power source 116 and a second end (shown in FIG. 2) adjacent to the mobile machine 102. In an embodiment, the fiber optic cable 140 may be disposed within the outer casing of the electric cable 120. In an alternative embodiment, the fiber optic cable 140 may be coupled with the electric cable 120 on an outer surface thereof. In an example, multiple fasteners, such as clamps or clips, may couple the fiber optic cable 140 to the outer surface of the electric cable 120. Hence, the fiber optic cable 140 may follow a movement of the electric cable 120 and may attain a shape that is substantially similar to a shape of the electric cable 120. Further, the fiber optic cable 140 may also be guided by the cable guides 130 along with the electric cable 120. In an embodiment, the fiber optic cable 140 may be formed by coupling multiple fiber optic cable segments. Adjacent fiber optic cable segments may be joined to each other by various methods known in the art, for example, fusion splicing, fiber connectors, or the like. In one embodiment, the fiber optic cable 140 may extend along substantially the entire length of the electric cable 120, or only along a portion thereof. In some instances, multiple fiber optic cables 140 may be positioned in spaced orientation along the length of electric cable 120, for example, separated by a desired distance, in which case, the position of the electric cable 120 along the distance not covered determined directly by the fiber optic cable 140 as described may need to be estimated by the system 125. For example, using the known distance between the fiber optic cables 140, an avoidance zone may be established using the calculated possible positions of the electric cable 120.

FIG. 2 illustrates a sectional perspective view of the fiber optic cable 140, according to an embodiment of the present disclosure. The fiber optic cable 140 may extend between the first end 202 and the second end 204 defining a length ‘L’. The fiber optic cable 140 may include at least one core 210 that may extend between the first end 202 and the second end 204. The core 210 may pass through center of the fiber optic cable 140 and is configured to be a light-carrying element. Although the fiber optic cable 140 includes one core 210, in the illustrated embodiment, it may be contemplated that the system 125 may include a fiber optic cable having multiple cores. The core 210 may be further surrounded by a layer of cladding 212. A material of the core 210 and the cladding 212 may be a polymer, such as polystyrene, PMMA, or the like known in the art. The material used for making the core 210 may have a high transparency and the material used for the cladding 212 may have a refractive index lower than the material of the cores 210. A difference between the refractive indices between the core 210 and the cladding 212 may provide total internal reflection of light to be transmitted within the core 210

The fiber optic cable 140 may also include a plurality of strain sensors 214 distributed along the length of the core 210. Each of the plurality of strain sensors 214 may be disposed in the core 210 such that a distance between every adjacent strain sensors 214 may be kept substantially equal. Each of the strain sensors 214 may be, for example, a Fiber Bragg Gratings (FBGs) or a Rayleigh Scatter Detector. The strain sensors 214 may be further configured to estimate bending and/or twisting of the fiber optic cable 140 at each location of the strain sensor 214.

Further, a layer 218 made from a polymer may be bonded to the cladding 212. The layer 218 may act as a protective coating. The layer 218 may be further surrounded by a sleeve 220 that may be made from a reinforcing polymeric material, such as aramid. Specifically, the sleeve 220 may surround the cladding 212 along the length ‘l’ of the fiber optic cable 140.

The fiber optic cable 140, shown in FIG. 2, may be exemplary and should not be treated as a limitation to the scope of the present disclosure. It may also be contemplated that the system 125 may include a fiber optic cable assembly having multiple fiber optic cables received within a jacket.

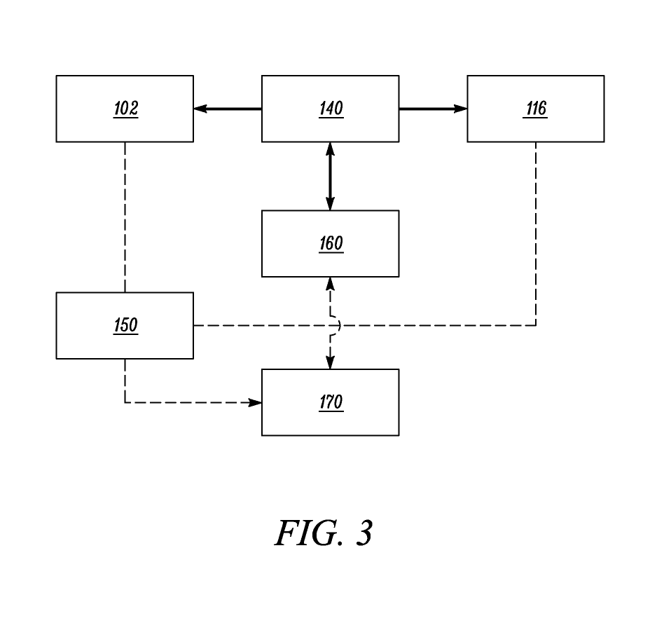

FIG. 3 shows a block diagram illustrating the system 125, according to an embodiment of the present disclosure. Referring to FIGS. 1 to 3, the system 125 may include a positioning device 150. In an embodiment, the positioning devices 150 may be associated with at least one of the power source 116 and the mobile machine 102. Further, the positioning device 150 may be configured to generate a signal indicative of a position of at least one of the power source 116 and/or the mobile machine 102. The positioning device 150 associated with the mobile machine 102 may be disposed on an axis of rotation of the body 106 relative to the undercarriage. However, it may be contemplated that the positioning device 150 may be disposed at any location on the mobile machine 102. The positioning device 150 may be a satellite positioning system, for example, a Global Positioning System (GPS). Thus, the positioning device 150 may be configured to determine GPS coordinates of the power source 116 and the mobile machine 102. The location of the power source 116 and the mobile machine 102 relative to the worksite 100 may be determined based on the corresponding GPS Coordinates. In another embodiment, wherein the position of the power source 116 is relatively fixed, the location thereof can be provided to the system 125.

The system 125 may further include a shape sensing device 160 disposed in communications with the fiber optic cable 140. Further, the shape sensing device 160 may be configured to receive signals from the plurality of strain sensors 214 of the fiber optic cable 140. The shape sensing device 160 may be further configured to generate a position data set based on the signals received from the plurality of strain sensors 214. The position data set may be indicative of a shape of the fiber optic cable 140. The shape sensing device 160 may be in communication with at least one of the first end 202 and the second end 204 of the fiber optic cable 140. In an embodiment, the first end 202 of the fiber optic cable 140 may be in communication with the shape sensing device 160. Hence, a reference system for determining the shape of the fiber optic cable 140 may be defined based on the location of the power source 116. The reference system may be a Cartesian coordinate system. In an alternative embodiment, the shape sensing device 160 may be in communication with second end 204 of fiber optic cable 140. Hence, the reference system for determining the shape of the fiber optic cable 140 may be defined based on the location of the mobile machine 102. The shape sensing device 160 may be directly coupled to the first or second ends 202, 204 of the fiber optic cable 140. Alternatively, a separate cable may communicate the shape sensing device 160 with the first end 202 or the second end 204 of the fiber optic cable 140. The separate cable may also be a fiber optic cable. It may be contemplated that the reference system for determining the shape of the fiber optic cable 140 may be defined based on any location irrespective of the location of the shape sensing device 160.

In an embodiment, the shape sensing device 160 may include a transmitter and a receiver. The transmitter may be configured to convert an electrical signal into an optical signal and provide the optical signal as an input to the fiber optic cable 140. The transmitter may be a laser diode or a Light Emitting Diode (LED). The receiver may be configured to receive the optical signal and convert the optical signal into an electrical signal. The optical signal may correspond to strain experienced by each of the strain sensors 214. The receiver may also include one or more signal converters, signal filters, signal amplifiers, and demodulators. The shape sensing device 160 may further generate the position data set corresponding to the shape of the fiber optic cable 140 based on the optical signal received from the fiber optic cable 140.

The system 125 may further include a controller 170 configured to be in communication with the shape sensing device 160 and the positioning device 150. The controller 170 may be disposed at any location within the worksite 100. Alternatively, the controller 170 may be remotely located with respect to the worksite 100. The controller 170 may be configured to receive signals from the shape sensing device 160 corresponding to the shape of the fiber optic cable 140. Specifically, the controller 170 may receive the position data set from the shape sensing device 160. Further, the controller 170 may receive signals from the positioning device 150 corresponding to the position of at least one of the mobile machine 102 and the power source 116. In an embodiment, the controller 170 may receive signals from the shape sensing device 160 and the positioning device 150 via wireless communication. The controller 170 may be further configured to store data received from the shape sensing device 160 and the positioning device 150. The controller 170 may also be configured to process the received data. In an embodiment, the controller 170 may be further configured to determine a position of the electric cable 120 along the worksite 100 at or above the surface 122 of the worksite 100 based on the position data set and the position of at least one of the mobile machine 102 and the power source 116. In an example, the controller 170 may be configured to determine the shape of the electric cable 120 with respect to one of the mobile machine 102 and the power source 116. Specifically, the controller 170 may be configured to generate an output (not shown) including a location of the electric cable 120 in the reference system based on the position data set and GPS coordinates of at least one of the mobile machine 102 and the power source 116. The output may be displayed via a display device associated with the controller 170.

The controller 170 may also be configured to determine an avoidance region 180 (shown in FIG. 1) based on the position of the electric cable 120. The avoidance region 180 may correspond to a region for avoidance by equipment and personnel. The avoidance region 180 shown in FIG. 1 is exemplary in nature, and the shape and/or size of the avoidance region 180 may also vary based on various factors in addition to the position of the electric cable 120, such as an amount of slack in the electric cable 120, the angular rotation of the body 106 of the mobile machine 102 etc.

### INDUSTRIAL APPLICABILITY

The present disclosure relates to the system 125 for locating the electric cable 120 connected between the mobile machine 102 and the power source 116 such that the avoidance region 180 may be determined in the worksite 100. The avoidance region 180 may correspond to a region of the worksite 100 disposed between a rear of the mobile machine 102 and the adjacent cable guide 130. Specifically, the avoidance region 180 may be defined around the portion 132 of the electric cable 120.

In an embodiment, the controller 170 may generate a map of the worksite 100. Alternatively, the controller 170 may access a map stored in a database. The controller 170 may also determine locations of the mobile equipment 124, the mobile machine 102, the power source 116, the electric cable 120, various mining regions, and the like on the map. Further, the controller 170 may determine the location of the avoidance region 180 on the map of the worksite 100. In case one or more of the mobile equipment 124 are autonomously controlled, the controller 170 may regulate the mobile equipment 124 based on the avoidance region 180, for example, by stopping the mobile equipment 124 from entering the avoidance region 180, or by executing an alternative path for the mobile equipment 124 to travel. In case one or more of the mobile equipment 124 are manually controlled, the controller 170 may communicate information related to the avoidance region 180 to operators of the mobile equipment 124, for example, by displaying the location of the avoidance region 180 (and thus the electric cable 120) on a display within the operator's view or providing other visual or audible alarms. Additionally, the controller 170 may also communicate information related to the avoidance region 180 to other personnel overseeing various operations in the worksite 100.

The controller 170 may update the avoidance region 180 in real time based on various factors, such as changes in the position of the electric cable 120 and location of the mobile machine 102 during operation. The avoidance region 180 may also be changed based on previous positions of the electric cable 120. Thus, the avoidance region 180 may enable the mobile equipment 124 and personnel to avoid contact with the electric cable 120 so as to prevent damage to the electric cable 120 and/or the mobile equipment 124.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof. For example, it should be appreciated that instead of electric cables, the fiber optic system may be employed with fluid conduits tethered to a machine.

What is claimed is:

1. A system configured to locate an electric cable tethered from a mobile machine along a worksite at or above a surface of the worksite, the electric cable configured to transmit electric power to the mobile machine from a power source, the system comprising:
a fiber optic cable associated with the electric cable, the fiber optic cable disposed between the power source and the mobile machine, the fiber optic cable comprising at least one core and a plurality of strain sensors distributed along a length of the at least one core;
a shape sensing device disposed in communication with the fiber optic cable, the shape sensing device configured to receive signals from the plurality of strain sensors, the shape sensing device further configured to generate a position data set indicative of a shape of the fiber optic cable;
a positioning device configured to determine a position of at least one of the mobile machine and the power source; and
a controller disposed in communication with the shape sensing device and the positioning device, the controller configured to determine a position of the electric cable along the worksite at or above a surface of the worksite based on the position data set and the position of at least one of the mobile machine and the power source, the controller further configured to determine an avoidance region based on the position of the electric cable, wherein the avoidance region corresponds to a region for avoidance by equipment or personnel.
